(19) United States
(12) Patent Application Publication
(10) Pub. No.: US 2022/0175186 A1
(43) Pub. Date: Jun. 9, 2022

(54) AIR FRYER WITH REMOVABLE HEATING COIL FOR CLEANING

(71) Applicant: DANA DAVIS, Richmond, VA (US)

(72) Inventor: DANA DAVIS, Richmond, VA (US)

(21) Appl. No.: 17/114,626

(22) Filed: Dec. 8, 2020

(51) Int. Cl. A47J 37/06; F24C 7/08; F24C 7/06; A47J 36/32

(52) U.S. Cl. CPC A47J 37/0641; A47J 36/32; F24C 7/06; F24C 7/087

(57) ABSTRACT

The air fryer with removable heating coil for cleaning is an appliance. The air fryer with removable heating coil for cleaning is an oven. The air fryer with removable heating coil for cleaning is configured for use with a foodstuff. The air fryer with removable heating coil for cleaning incorporates a thermal shell, a cooking pan, and a control circuit. The thermal shell contains the control circuit. The cooking pan inserts into the thermal shell. The foodstuff is contained in the cooking pan. The control circuit is an electric circuit. The control circuit generates and controls the heat necessary to heat the foodstuff within the cooking pan.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of kitchen equipment for baking, roasting, grilling, and frying more specifically, a small sized cooking oven with an at least partially closed cooking cavity. (A47J37/0623)

### SUMMARY OF INVENTION

The air fryer with removable heating coil for cleaning is an appliance. The air fryer with removable heating coil for cleaning is an oven. The air fryer with removable heating coil for cleaning is configured for use with a foodstuff. The air fryer with removable heating coil for cleaning comprises a thermal shell, a cooking pan, and a control circuit. The thermal shell contains the control circuit. The cooking pan inserts into the thermal shell. The foodstuff is contained in the cooking pan. The control circuit is an electric circuit. The control circuit generates and controls the heat necessary to heat the foodstuff within the cooking pan.

These together with additional objects, features and advantages of the air fryer with removable heating coil for cleaning will be readily apparent to those of ordinary skill in the art upon reading the following detailed description of the presently preferred, but nonetheless illustrative, embodiments when taken in conjunction with the accompanying drawings.

In this respect, before explaining the current embodiments of the air fryer with removable heating coil for cleaning in detail, it is to be understood that the air fryer with removable heating coil for cleaning is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the air fryer with removable heating coil for cleaning.

It is therefore important that the claims be regarded as including such equivalent construction insofar as they do not depart from the spirit and scope of the air fryer with removable heating coil for cleaning. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a front view of an embodiment of the disclosure.

FIG. 4 is an in-use view of an embodiment of the disclosure.

FIG. 5 is a top view of an embodiment of the disclosure.

FIG. 6 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

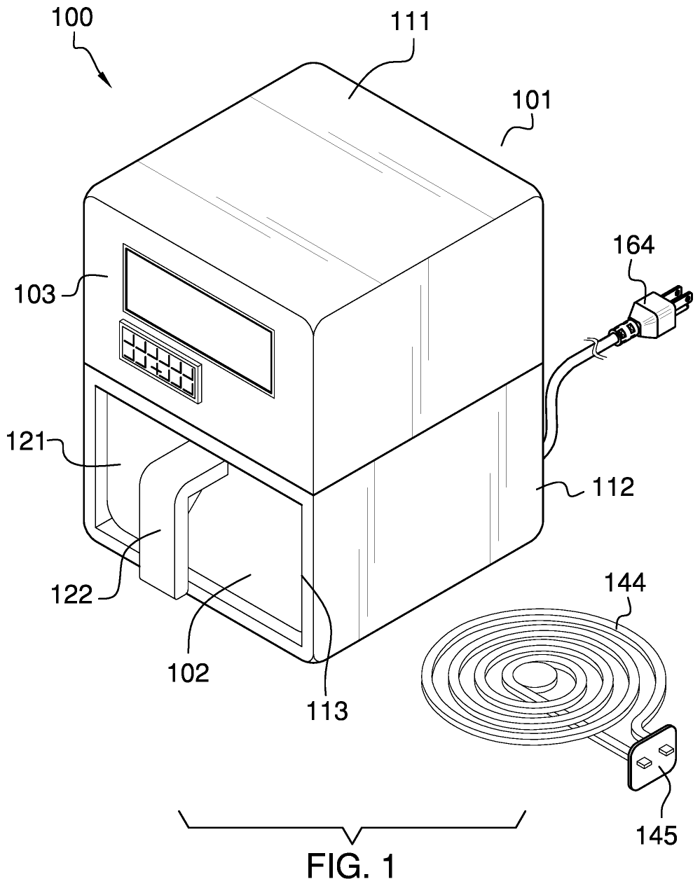

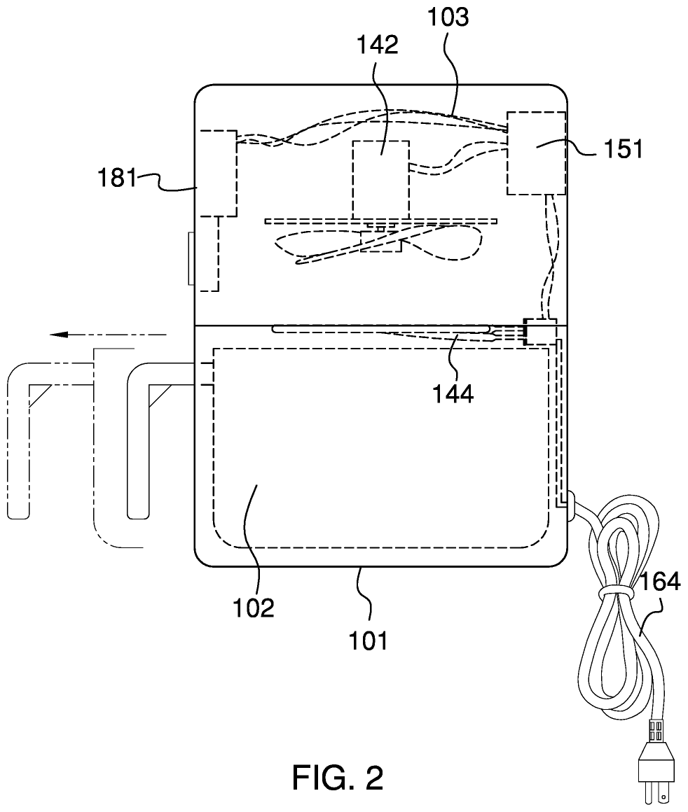

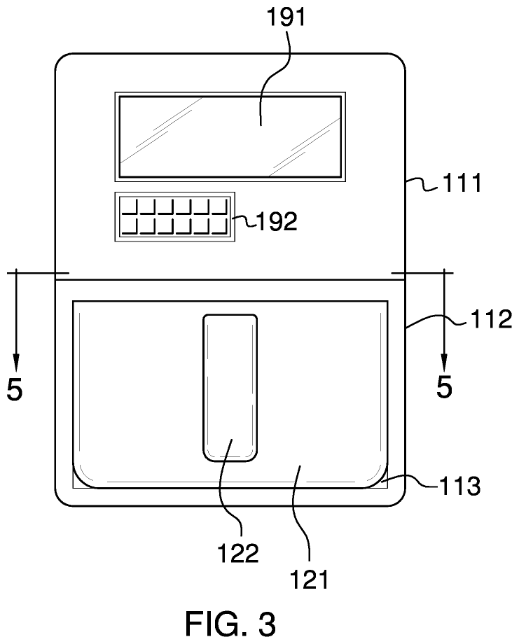

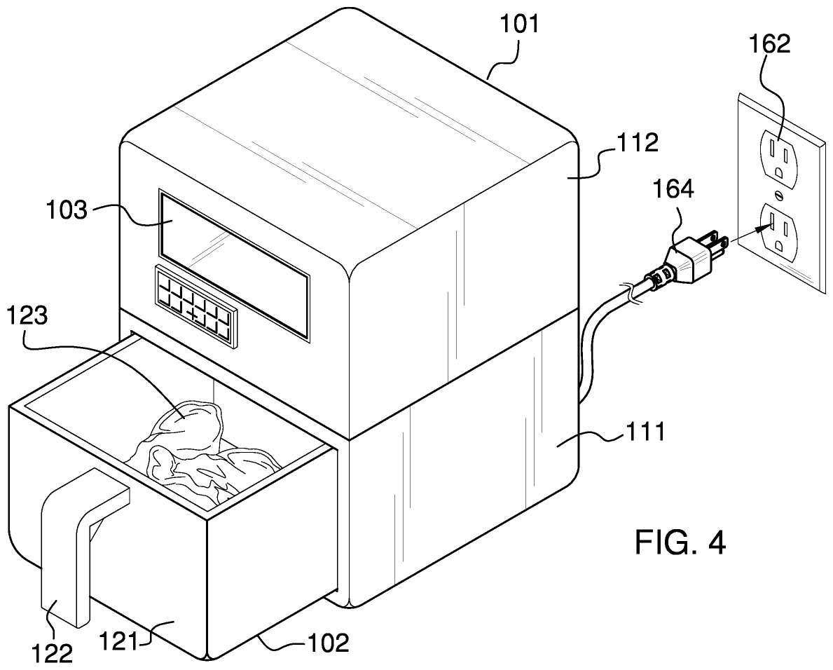

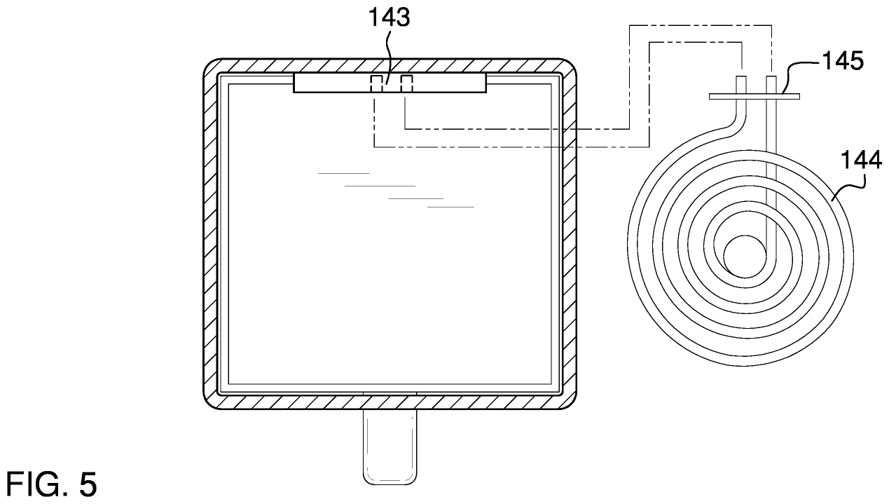

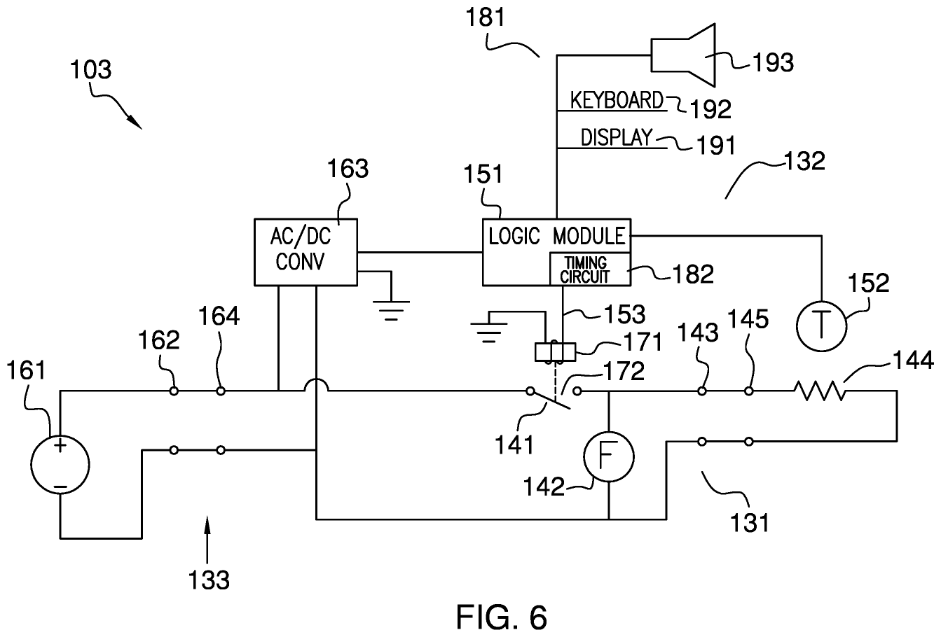

Detailed reference will now be made to one or more potential embodiments of the disclosure, which are illustrated in FIGS. 1 through 6.

The air fryer with removable heating coil for cleaning is an appliance 100 (hereinafter invention). The invention 100 for cleaning is an oven. The invention 100 for cleaning is configured for use with a foodstuff 123. The invention 100 for cleaning comprises a thermal shell 101, a cooking pan 102, and a control circuit 103. The thermal shell 101 contains the control circuit 103. The cooking pan 102 inserts into the thermal shell 101. The foodstuff 123 is contained in the cooking pan 102. The control circuit 103 is an electric circuit. The control circuit 103 generates and controls the heat necessary to heat the foodstuff 123 within the cooking pan 102.

The thermal shell 101 is a rigid structure. The thermal shell 101 contains the cooking pan 102 and the control circuit 103. The thermal shell 101 is formed with all apertures and form factors necessary to allow the thermal shell 101 to accommodate the use and operation of the invention 100. Methods to form a thermal shell 101 suitable for the purposes described in this disclosure are well-known and documented in the mechanical arts. The thermal shell 101 is a hollow structure. The thermal shell 101 is a prism-shaped structure. The thermal shell 101 is formed as a composite prism. The thermal shell 101 is an insulating structure. The thermal shell 101 forms the exterior surfaces of the invention 100. The thermal shell 101 comprises a circuit chamber 111 and a cooking chamber 112.

The circuit chamber 111 is a rigid structure. The circuit chamber 111 is a prism-shaped structure. The circuit chamber 111 is a hollow structure. The circuit chamber 111 has a pan shape. The circuit chamber 111 attaches to the cooking chamber 112 to form the composite prism structure of the thermal shell 101.

The cooking chamber 112 is a rigid structure. The cooking chamber 112 is a prism-shaped structure. The cooking chamber 112 is a hollow structure. The cooking chamber 112 has a semi-enclosed pan shape. The open face of the pan structure of the cooking chamber 112 attaches to the open face of the pan structure of the circuit chamber 111 to form the composite prism structure of the thermal shell 101. The semi-enclosed pan structure of the cooking chamber 112 causes the composite prism structure of the thermal shell 101 to have a semi-enclosed composite prism structure. The cooking chamber 112 is sized to receive the cooking pan 102. A gas impermeable seal is formed when the cooking pan 102 inserts into the cooking chamber 112.

The cooking chamber 112 receives the heat generated by the control circuit 103 such that the generated heat is transferred to the foodstuff 123 contained in the cooking pan 102.

The cooking chamber 112 further comprises a pan aperture 113. The pan aperture 113 is an aperture that is formed through a lateral face of the pan shape of the cooking chamber 112. The pan aperture 113 gives the cooking chamber 112 its semi-enclosed pan shape. The pan aperture 113 forms the aperture that allows the cooking pan 102 to insert into the cooking chamber 112.

The cooking pan 102 is a rigid structure. The cooking pan 102 is a hollow structure. The cooking pan 102 is a prism-shaped structure. The cooking pan 102 is formed as a pan. The cooking pan 102 is an insulating structure. The cooking pan 102 contains the foodstuff 123 as the invention 100 is heating the foodstuff 123. The cooking pan 102 forms a drawer that removably inserts into the cooking chamber 112 of the thermal shell 101. The cooking pan 102 comprises a drawer structure 121 and a handle 122.

The drawer structure 121 is a rigid structure. The drawer structure 121 is a prism-shaped structure. The drawer structure 121 is a hollow structure. The drawer structure 121 has a pan shape. The lateral faces of the pan structure of the drawer structure 121 are geometrically similar to the pan aperture 113 of the cooking chamber 112. The lateral faces of the pan structure of the drawer structure 121 are sized such that the lateral face of the drawer structure 121 inserts into the cooking chamber 112 through the pan aperture 113. The drawer structure 121 forms the containment space that stores the foodstuff 123 while the invention 100 is heating the foodstuff 123.

The drawer structure 121 is sized such that the drawer structure 121 forms a gas impermeable seal when inserted into the cooking chamber 112. The drawer structure 121 inserts into the cooking chamber 112 to form a composite prism structure with the cooking chamber 112.

The handle 122 attaches to the exterior surface of the drawer structure 121. The handle 122 is a grip that attaches to the exterior surface of a lateral face of the drawer structure 121. The handle 122 mounts on the lateral face that forms the exterior surface of the invention 100 when the drawer structure 121 is fully inserted into the invention 100.

The control circuit 103 is an electric circuit. The control circuit 103 converts electric energy into thermal energy used to heat the foodstuff 123 in the cooking pan 102. The control circuit 103 controls the temperature within the cooking pan 102 during the cooking process. The control circuit 103 generates a flow of air within the hollow interior of the cooking pan 102. The control circuit 103 comprises a heating circuit 131, a logic circuit 132, and a power circuit 133. The heating circuit 131, the logic circuit 132, and the power circuit 133 are electrically interconnected.

The heating circuit 131 is an electric circuit. The heating circuit 131 heats the air in the interior space of the thermal shell 101. The heating circuit 131 circulates the air in the interior space of the cooking chamber 112. The power circuit 133 provides the electric energy necessary to operate the heating circuit 131. The logic circuit 132 controls the operation of the heating circuit 131. The heating circuit 131 receives the electric energy needed for operation from the power circuit 133. The heating circuit 131 comprises a relay 141, a convection fan 142, a heating coil 144 port 143, and a heating coil 144. The heating coil 144 further comprises a heating coil 144 plug 145. The relay 141, the convection fan 142, the heating coil 144 port 143, the heating coil 144, and the heating coil 144 plug 145 are electrically interconnected.

The relay 141 is an electric switching device. The relay 141 is defined elsewhere in this disclosure. The logic circuit 132 controls the operation of the relay 141. The relay 141 forms a switchable electric connection that transfers ac electric energy from the power circuit 133 to the convection fan 142. The relay 141 forms a switchable electric connection that transfers ac electric energy from the power circuit 133 to the heating coil 144 port 143. The relay 141 further comprises a relay 141 coil 171, and a relay 141 switch 172.

The relay 141 coil 171 forms the energizing coil of the relay 141 that operates the relay 141 switch 172. The relay 141 coil 171 is defined elsewhere in this disclosure. The relay 141 switch 172 forms the electric switch that controls the flow of electric energy through the convection fan 142 and the heating coil 144. The relay 141 switch 172 is defined elsewhere in this disclosure.

The convection fan 142 is an electrically powered fan. The convection fan 142 blows air from the interior space of the circuit chamber 111 and over the heating coil 144 into the cooking chamber 112. The convection fan 142 continuously blows air into the cooking chamber 112 while the heating coil 144 is in use.

The heating coil 144 port 143 is a port. The port is defined elsewhere. The heating coil 144 port 143 forms an electrical connection that allows the heating coil 144 to form a detachable electric connection with the balance of the heating circuit 131. The heating coil 144 port 143 allows the heating coil 144 to be disconnected and detached from the balance of the invention 100 for cleaning and then to be subsequently reattached and electrically reconnected.

The heating coil 144 is a heating element. The heating element is defined elsewhere in this disclosure. The heating coil 144 converts ac electric energy into heat. The heating coil 144 generates the heat used to warm the interior space of the cooking chamber 112.

The heating coil 144 plug 145 is a plug that forms the detachable electric connection with the heating coil 144 port 143. The heating coil 144 plug 145 transmits the electric energy presented by the heating coil 144 port 143 to the relay 141.

The logic circuit 132 is an electric circuit. The logic circuit 132 controls the operation of the heating circuit 131.

The logic circuit 132 forms an interface 181 that receives externally provided operating instructions for the invention 100. The logic circuit 132 maintains the temperature within the cooking chamber 112 at a temperature received through the interface 181. The logic circuit 132 maintains a countdown timing device that discontinues the operation of the heating circuit 131 after a previously determined amount of time has elapsed. The logic circuit 132 receives the previously determined amount of time from the interface 181. The logic circuit 132 comprises a logic module 151, a thermostat 152, and a relay 141 coil 171 actuation signal 153. The logic module 151, the thermostat 152, and the relay 141 coil 171 actuation signal 153 are electrically interconnected.

The logic module 151 is a programmable electrical circuit. The logic module 151 monitors the temperature of the air in the cooking chamber 112. The logic module 151 controls the operation of the relay 141. The logic module 151 controls the temperature within the cooking chamber 112 by controlling the flow of electricity into the heating coil 144 of the heating circuit 131. The logic module 151 controls the electricity flowing through the heating coil 144 by controlling the flow of electricity through the relay 141. The logic module 151 operates the interface 181 such that the logic module 151 receives and processes externally provided operating instructions such as the temperature desired in the cooking chamber 112 and the amount of time the temperature should be maintained in the cooking chamber 112. The logic module 151 further comprises an interface 181 and a timing circuit 182.

The interface 181 forms a data exchange structure that: a) receives externally provided operating instructions; and, b) provides information regarding the operating status of the invention 100 in visually and audibly accessible forms. The interface 181 comprises a display device 191, a keyboard 192, and a speaker 193.

The display device 191 is an electric device. The display device 191 presents information regarding the operation of the invention 100 in a visual format. The logic module 151 controls the operation of the display device 191. The display device 191 is defined elsewhere in this disclosure.

The keyboard 192 is an electric device. The keyboard 192 receives information regarding the desired operating parameters of the invention 100. The logic module 151 monitors the data received by the keyboard 192. The keyboard 192 is defined elsewhere in this disclosure.

The speaker 193 is an electric device. The speaker 193 presents information regarding the operation of the invention 100 in an audible format. The logic module 151 controls the operation of the speaker 193. The speaker 193 is defined elsewhere in this disclosure.

The timing circuit 182 is an electric circuit that is incorporated in the logic module 151. The timing circuit 182 forms a countdown timing device used by the logic module 151 to limit the amount of time the heating circuit 131 can operate.

The thermostat 152 is a sensor that measures the temperature in the cooking chamber 112. The thermostat 152 transmits the temperature data to the logic module 151. The logic module 151 uses the received temperature to determine when to activate and deactivate the relay 141 of the heating circuit 131. The relay 141 coil 171 actuation signal 153 is an electric signal that is generated by the logic module 151.

The relay 141 coil 171 actuation signal 153 electrically connects to the relay 141 coil 171. The logic module 151 initiates the operation of the heating coil 144 by using the relay 141 coil 171 actuation signal 153 to energize the relay 141 coil 171 and close the relay 141 switch 172. The relay 141 coil 171 actuation signal 153 discontinues the operation of the heating coil 144 by using the relay 141 coil 171 actuation signal 153 to deenergize the relay 141 coil 171 and open the relay 141 switch 172.

The power circuit 133 is an electric circuit. The power circuit 133 receives ac electric energy from the national electric grid 161. The power circuit 133 transmits a portion of the received ac electric energy to the heating circuit 131. The power circuit 133 converts a portion of the received ac electric energy into dc electric energy. The power circuit 133 transmits the generated dc electric energy to the logic circuit 132. The power circuit 133 comprises a national electric grid 161, a national electric grid 161 port 162, an ac/dc converter 163, and a national electric grid 161 plug 164. The national electric grid 161, the national electric grid 161 port 162, the ac/dc converter 163, and the national electric grid 161 plug 164 are electrically interconnected.

The national electric grid 161 is an externally provided source of electric energy. The national electric grid 161 is defined elsewhere in this disclosure. The national electric grid 161 port 162 is a port used to transmit electric energy from the national electric grid 161 to the heating circuit 131. In the first potential embodiment of the disclosure, the national electric grid 161 port 162 is a NEMA 5-15 electrical socket. The NEMA 5-15 electrical socket is defined elsewhere in this disclosure.

The ac/dc converter 163 is an electric circuit. The ac/dc converter 163 is defined elsewhere in this disclosure. The ac/dc converter 163 converts ac electric energy from the national electric grid 161 port 162 and converts the received ac electric energy into the dc electric energy required to operate the logic circuit 132.

The national electric grid 161 plug 164 is a plug used to draw electric energy from the national electric grid 161 through the national electric grid 161 port 162. The national electric grid 161 plug 164 forms electric connections with both the ac/dc converter 163 and the relay 141 switch 172. In the first potential embodiment of the disclosure, the national electric grid 161 plug 164 is a NEMA 5-15 electrical plug. The NEMA 5-15 electrical plug is defined elsewhere in this disclosure.

The following definitions were used in this disclosure:

AC: As used in this disclosure, AC is an acronym for alternating current.

AC/DC Converter: As used in this disclosure, an AC/DC converter is an electrical device that converts an AC voltage into a regulated DC voltage by rectifying and regulating the AC voltage. Method to design and build AC/DC converters are well known in the electrical arts. The AC/DC converter is further defined with a positive terminal, a negative terminal and a power input.

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Appliance: As used in this disclosure, an appliance is an externally powered device or instrument intended for household use.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Clean: As used in this disclosure, the term clean refers to an object without dirt, unwanted markings, or undesirable pathogens. When referring to a surface, the term clean can also refer to removing unwanted objects from the surface. The term cleaning refers to the action of making an object clean.

Coil: As used in this disclosure, a coil is a structure that has the shape of a helix, volute, or a spiral. The structure of the coil is often a cord, wire, hose, or tube.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Control Circuit: As used in this disclosure, a control circuit is an electrical circuit that manages and regulates the behavior or operation of a device.

Correspond: As used in this disclosure, the term correspond is used as a comparison between two or more objects wherein one or more properties shared by the two or more objects match, agree, or align within acceptable manufacturing tolerances.

DC: As used in this disclosure, DC is an acronym for direct current.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Display: As used in this disclosure, a display is a surface upon which is presented an image, potentially including, but not limited to, graphic images and text, that is interpretable by an individual viewing the projected image in a meaningful manner. A display device refers to an electrical device used to present these images.

Drawer: As used in this disclosure, a drawer is a box or pan that is designed to slide into and out of a larger object.

Exterior: As used in this disclosure, the exterior is used as a relational term that implies that an object is not contained within the boundary of a structure or a space.

External Power Source: As used in this disclosure, an external power source is a source of the energy that is externally provided to enable the operation of the present disclosure. Examples of external power sources include, but are not limited to, electrical power sources and compressed air sources.

Fan: As used in this disclosure, a fan is a mechanical device with rotating blades that is used to create a flow or current of air.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Grip: As used in this disclosure, a grip is an accommodation formed on or within an object that allows the object to be grasped or manipulated by a hand.

Handle: As used in this disclosure, a handle is an object by which a tool, object, or door is held or manipulated with the hand.

Heat Transfer: As used in this disclosure, heat transfer refers an exchange of thermal energy between a first object and a second object. In thermodynamics the first and second objects are often referred to as systems. This disclosure assumes that heat transfer occurs through three mechanisms: conduction, convection, and radiation. By conduction is meant that the heat is exchanged through the contact between the first object and the second object which facilitates the direct transfer of the energy of the vibration of the molecules of the first object to the molecules of the second object. By convection is meant that the heat is transferred through the exchange or movement of mass within and between the first object and the second object. By radiation is meant the transfer of heat energy in the form of (typically electromagnetic) waves between the first object and the second object.

Heating Element: As used in this disclosure, a heating element is a resistive wire that is used to convert electrical energy into heat. Common metal combinations used to form heat elements include a combination of nickel and Chromium (typical: 80/20), a combination of iron, chromium and aluminum (typical 70/25/5), a combination of copper, nickel, iron, and manganese (typical 66/30/2/2) (use for continuously hot), and platinum.

Helix: As used in this disclosure, a helix is the three-dimensional structure that would be formed by a wire that is wound uniformly around the surface of a cylinder or a cone. If the wire is wrapped around a cylinder the helix is called a cylindrical helix. If the wire is wrapped around a cone, the helix is called a conical helix. A synonym for conical helix would be a volute.

Insulating Structure: As used in this disclosure, an insulating structure is a structure that inhibits, and ideally prevents, the transfer of heat through the insulating structure. Insulating structures may also be used to inhibit or prevent the transfer of sound through the insulating structure. Methods to form insulating structures include, but are not limited to: 1) the use of materials with low thermal conductivity; and, 2) the use of a structural design that places a vacuum within the insulating structure within the anticipated transfer path of the heat or sound.

Interface: As used in this disclosure, an interface is a physical or virtual boundary that separates two different systems across which information is exchanged.

Interior: As used in this disclosure, the interior is used as a relational term that implies that an object is contained within the boundary of a structure or a space.

Keyboard: As used in this disclosure, a keyboard is a panel that further comprises a plurality of buttons that are commonly referred to as keys. The keyboard is commonly used to operate devices including, but not limited to, logical devices and musical instruments.

Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs. The disclosure allows, but does not assume, that the logic module is programmable.

National Electric Grid: As used in this disclosure, the national electric grid is a synchronized and highly interconnected electrical network that distributes energy in the form of electric power from a plurality of generating stations to consumers of electricity. The national electric grid is a commercially available source of AC electrical power. The national electric grid is regulated by an appropriate authority. The national electric grid sells electrical power for use by an electrical load. The national electric grid invoices for electrical power based on the total energy consumed by the electrical load. The national electric grid measures the energy consumption of an electrical load with an electrical meter. The national electric grid provides power through electrical connections known as a hot lead and a neutral lead.

NEMA: As used in this disclosure, NEMA is an acronym for National Electric Manufacturers Association. NEMA is a manufacturer's association known for publishing widely accepted technical standards regarding the performance of electrical power distribution equipment.

NEMA 5-15 Electrical Socket: As used in this disclosure, the NEMA 5-15 electrical socket is a port designed to provide electric power drawn from a source of electrical power consistent with the electrical power received through the National Electric Grid. The NEMA 5-15 electrical socket is commonly used to deliver electrical power to electric devices in residential, office, and light industrial settings. The typical NEMA5-15 electrical socket comprises a plurality of electric ports from which electric power is drawn. The position of each of the plurality of electric ports is placed in a standardized position. The typical NEMA5-15 electrical socket further comprises a plate hole which is a standardized hole located in a standardized position within the NEMA 5-15 electrical socket that that is designed to receive a bolt that is used to attach a faceplate to the NEMA 5-15 electrical socket. The NEMA 5-15 electrical socket is also commonly referred to as an electrical outlet.

NEMA 5-15P Electrical Plug: As used in this disclosure, the NEMA 5-15P Electrical Plug is a plug that is designed to be inserted into a NEMA 5-15 Electrical Socket for the purpose of delivering electrical power to electrical devices. The NEMA 5-15P Electrical Plug is a 3 blade plug that is commonly found within residential and office environments within the United States.

Normally Closed: As used in this disclosure, normally closed refers to an externally controlled electrical switching device, such as a relay or a momentary switch, which passes electric current when the externally controlled electrical switching device is in an unpowered state. In a common alternate usage, the term normally closed valve is taken to mean that the normally closed valve prevents the flow of fluid through the normally closed valve when the normally closed valve is in an unpowered state.

Normally Open: As used in this disclosure, normally open refers to an externally controlled electrical switching device, such as a relay or a momentary switch, which does not pass electric current when the externally controlled electrical switching device is in an unpowered state. In a common alternate usage, the term normally open valve is taken to mean that the normally open valve allows the flow of fluid through the normally open valve when the normally open valve is in an unpowered state.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Oven: As used in this disclosure, an oven is an enclosed chamber that is equipped to heat objects placed within the enclosed chamber.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan is are open.

Perimeter: As used in this disclosure, a perimeter is one or more curved or straight lines that bounds an enclosed area on a plane or surface. The perimeter of a circle is commonly referred to as a circumference.

Plug: As used in this disclosure, a plug is an electrical termination that electrically connects a first electrical circuit to a second electrical circuit or a source of electricity. As used in this disclosure, a plug will have two or three metal pins.

Port: As used in this disclosure, a port is an electrical termination that is used to connect a first electrical circuit to a second external electrical circuit. In this disclosure, the port is designed to receive a plug.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Relay: As used in this disclosure, a relay is an automatic electromagnetic or electromechanical device that reacts to changes in voltage or current by opening or closing a switch in an electric circuit. Relays are further defined with a coil and a switch. Applying a voltage to the coil, usually referred to as energizing the coil, will cause the coil to change the position of the switch. Note: Though transistors can be configured to perform switching functions, transistors used for switching functions are handled separately in this disclosure and are explicitly excluded from this definition.

Semi-Enclosed Prism: As used in this disclosure, a semi-enclosed prism is a prism-shaped structure wherein a portion of the lateral face of the prism-shaped is removed or otherwise replaced with a negative space. Always use negative space.

Shell: As used in this disclosure, a shell is a structure that forms an outer covering intended to contain an object. Shells are often, but not necessarily, rigid or semi-rigid structures that are intended to protect the object contained within it.

Speaker: As used in this disclosure, a speaker is an electrical transducer that converts an electrical signal into an audible sound.

Spiral: As used in this disclosure, a spiral describes a locus of points within a plane moving around a fixed center wherein the locus of points moves in a monotonically increasing manner away from the center. A common example of a spiral has the polar coordinate equation: r=(a)×(theta) where r equals the polar radius and theta equals the polar angle.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

Thermostat: As used in this disclosure, a thermostat is a device that monitors the temperature of a space such that the thermostat 1) operates a switch when the measured temperature exceeds or falls below a first preset temperature; and, 2) performs the opposite operation on the switch when the measured temperature falls below or exceeds a second preset temperature. The thermostat is well-known and documented in the electrical arts.

Timing Circuit: As used in this disclosure, a timing circuit refers to an electrical network of interconnected electrical elements, potentially including but not limited to, resistors, capacitors, diodes, transistors, and integrated circuit devices. The purpose of the timing circuit is to generate an electrical control signal after a predetermined amount of time. In common usage, a timing circuit is also referred to as timing circuitry. The “555” timing circuit is a well-known, documented, and commercially available timing circuit.

Timing Device: As used in this disclosure, a timing device is an automatic mechanism for activating or deactivating a device at a specific time or after a specific period of time. This disclosure assumes that the logic module is provisioned with a timing circuit that can be used as a timing device. A timing device that activates an audible alarm is often referred to as a timer.

Transducer: As used in this disclosure, a transducer is a device that converts a physical quantity, such as pressure or brightness into an electrical signal or a device that converts an electrical signal into a physical quantity.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An air fryer with removable heating coil comprising
a thermal shell, a cooking pan, and a control circuit;
wherein the thermal shell contains the control circuit;
wherein the cooking pan inserts into the thermal shell;
wherein the air fryer with removable heating coil for cleaning is an oven;
wherein the air fryer with removable heating coil for cleaning is configured for use with a foodstuff;
wherein the foodstuff is contained in the cooking pan.

2. The air fryer with removable heating coil according to claim 1
wherein the thermal shell is a rigid structure;
wherein the thermal shell is a hollow structure;
wherein the thermal shell is formed as a composite structure;
wherein the thermal shell is an insulating structure;
wherein the thermal shell forms the exterior surfaces of the air fryer with removable heating coil.

3. The air fryer with removable heating coil according to claim 2
wherein the control circuit is an electric circuit;
wherein the control circuit converts electric energy into thermal energy used to heat the foodstuff in the cooking pan;
wherein the control circuit controls the temperature within the cooking pan during the cooking process;
wherein the control circuit generates a flow of air within the hollow interior of the cooking pan.

4. The air fryer with removable heating coil according to claim 3
wherein the thermal shell comprises a circuit chamber and a cooking chamber;
wherein the circuit chamber attaches to the cooking chamber to form the composite structure of the thermal shell.

5. The air fryer with removable heating coil according to claim 4
wherein the control circuit comprises a heating circuit, a logic circuit, and a power circuit;
wherein the heating circuit, the logic circuit, and the power circuit are electrically interconnected.

6. The air fryer with removable heating coil according to claim 5
wherein the heating circuit is an electric circuit;
wherein the heating circuit heats the air in the interior space of the thermal shell;
wherein the heating circuit circulates the air in the interior space of the cooking chamber;
wherein the power circuit provides the electric energy necessary to operate the heating circuit;
wherein the logic circuit controls the operation of the heating circuit;
wherein the heating circuit receives the electric energy needed for operation from the power circuit.

7. The air fryer with removable heating coil according to claim 6
wherein the logic circuit is an electric circuit;
wherein the logic circuit controls the operation of the heating circuit;
wherein the logic circuit forms an interface that receives externally provided operating instructions for the air fryer with removable heating coil;
wherein the logic circuit maintains the temperature within the cooking chamber at a temperature received through the interface;
wherein the logic circuit maintains a countdown timing device that discontinues the operation of the heating circuit after a previously determined amount of time has elapsed;
wherein the logic circuit receives the previously determined amount of time from the interface.

8. The air fryer with removable heating coil according to claim 7
wherein the power circuit is an electric circuit;
wherein the power circuit receives ac electric energy from the national electric grid;
wherein the power circuit transmits a portion of the received ac electric energy to the heating circuit;
wherein the power circuit converts a portion of the received ac electric energy into dc electric energy;
wherein the power circuit transmits the generated dc electric energy to the logic circuit.

9. The air fryer with removable heating coil according to claim 8
wherein the circuit chamber is a rigid structure;
wherein the circuit chamber is a hollow structure;
wherein the circuit chamber has a pan shape.

10. The air fryer with removable heating coil according to claim 9
wherein the cooking chamber is a rigid structure;
wherein the cooking chamber is a hollow structure;
wherein the cooking chamber has a semi-enclosed pan shape;
wherein the open face of the pan structure of the cooking chamber attaches to the open face of the pan structure of the circuit chamber to form the composite structure of the thermal shell;
wherein the semi-enclosed pan structure of the cooking chamber causes the composite structure of the thermal shell to have a semi-enclosed composite structure;
wherein the cooking chamber is sized to receive the cooking pan.

11. The air fryer with removable heating coil according to claim 10
wherein the heating circuit comprises a relay, a convection fan, a heating coil port, and a heating coil;
wherein the heating coil further comprises a heating coil plug;
wherein the relay, the convection fan, the heating coil port, the heating coil, and the heating coil plug are electrically interconnected;
wherein the logic circuit comprises a logic module, a thermostat, and a relay coil actuation signal;
wherein the logic module, the thermostat, and the relay coil actuation signal are electrically interconnected;
wherein the power circuit comprises a national electric grid, a national electric grid port, an ac/dc converter, and a national electric grid plug;
wherein the national electric grid, the national electric grid port, the ac/dc converter, and the national electric grid plug are electrically interconnected.

12. The air fryer with removable heating coil according to claim 11
wherein a gas impermeable seal is formed when the cooking pan inserts into the cooking chamber;
wherein the cooking chamber receives the heat generated by the control circuit such that the generated heat is transferred to the foodstuff contained in the cooking pan.

13. The air fryer with removable heating coil according to claim 12
wherein the cooking chamber further comprises a pan aperture;
wherein the pan aperture is an aperture that is formed through a lateral face of the pan shape of the cooking chamber;
wherein the pan aperture gives the cooking chamber its semi-enclosed pan shape;
wherein the pan aperture forms the aperture that allows the cooking pan to insert into the cooking chamber.

14. The air fryer with removable heating coil according to claim 13
wherein the cooking pan is a rigid structure;
wherein the cooking pan is a hollow structure;
wherein the cooking pan is formed as a pan;
wherein the cooking pan is an insulating structure;
wherein the cooking pan comprises a drawer structure and a handle;
wherein the handle attaches to the exterior surface of the drawer structure;
wherein the drawer structure is a rigid structure;
wherein the drawer structure is a hollow structure;
wherein the drawer structure has a pan shape.

15. The air fryer with removable heating coil according to claim 14
wherein the lateral faces of the pan structure of the drawer structure are geometrically similar to the pan aperture of the cooking chamber;
wherein the lateral faces of the pan structure of the drawer structure are sized such that the lateral face of the drawer structure inserts into the cooking chamber through the pan aperture;
wherein the drawer structure is sized such that the drawer structure forms the gas impermeable seal when inserted into the cooking chamber;
wherein the drawer structure inserts into the cooking chamber to form a composite structure with the cooking chamber.

16. The air fryer with removable heating coil according to claim 15
wherein the relay is an electric switching device;
wherein the logic circuit controls the operation of the relay;
wherein the relay forms a switchable electric connection that transfers ac electric energy from the power circuit to the convection fan;
wherein the relay forms a switchable electric connection that transfers ac electric energy from the power circuit to the heating coil port;
wherein the convection fan is an electrically powered fan;
wherein the convection fan blows air from the interior space of the circuit chamber and over the heating coil into the cooking chamber;
wherein the convection fan continuously blows air into the cooking chamber while the heating coil is in use;
wherein the heating coil port is a port;
wherein the heating coil port forms an electrical connection that allows the heating coil to form a detachable electric connection with the balance of the heating circuit;
wherein the heating coil port allows the heating coil to be disconnected and detached from the balance of the air fryer with removable heating coil for cleaning and then to be subsequently reattached and electrically reconnected;
wherein the heating coil is a heating element;
wherein the heating coil converts ac electric energy into heat;
wherein the heating coil generates the heat used to warm the interior space of the cooking chamber;
wherein the heating coil plug is a plug that forms the detachable electric connection with the heating coil port;
wherein the heating coil plug transmits the electric energy presented by the heating coil port to the relay.

17. The air fryer with removable heating coil according to claim 16
wherein the relay further comprises a relay coil, and a relay switch;
wherein the relay coil forms the energizing coil of the relay that operates the relay switch;
wherein the relay switch forms the electric switch that controls the flow of electric energy through the convection fan and the heating coil.

18. The air fryer with removable heating coil according to claim 17
wherein the logic module is a programmable electrical circuit;
wherein the logic module monitors the temperature of the air in the cooking chamber;
wherein the logic module controls the operation of the relay;
wherein the logic module controls the temperature within the cooking chamber by controlling the flow of electricity into the heating coil of the heating circuit;
wherein the logic module controls the electricity flowing through the heating coil by controlling the flow of electricity through the relay;
wherein the logic module operates the interface such that the logic module receives and processes externally provided operating instructions such as the temperature desired in the cooking chamber and the amount of time the temperature should be maintained in the cooking chamber;
wherein the thermostat is a sensor that measures the temperature in the cooking chamber;
wherein the thermostat transmits the temperature data to the logic module;
wherein the logic module uses the received temperature to determine when to activate and deactivate the relay of the heating circuit;
wherein the relay coil actuation signal is an electric signal that is generated by the logic module;
wherein the relay coil actuation signal electrically connects to the relay coil;
wherein the logic module initiates the operation of the heating coil by using the relay coil actuation signal to energize the relay coil and close the relay switch;
wherein the relay coil actuation signal discontinues the operation of the heating coil by using the relay coil actuation signal to deenergize the relay coil and open the relay switch.

19. The air fryer with removable heating coil according to claim 18
wherein the logic module further comprises an interface and a timing circuit;
wherein the interface forms a data exchange structure that: a) receives externally provided operating instructions; and, b) provides information regarding the operating status of the air fryer with removable heating coil in visually and audibly accessible forms;
wherein the interface comprises a display device, a keyboard, and a speaker;
wherein the display device is an electric device;
wherein the display device presents information regarding the operation of the air fryer with removable heating coil in a visual format;
wherein the logic module controls the operation of the display device;
wherein the keyboard is an electric device;
wherein the keyboard receives information regarding the desired operating parameters of the air fryer with removable heating coil;
wherein the logic module monitors the data received by the keyboard;
wherein the speaker is an electric device;
wherein the speaker presents information regarding the operation of the air fryer with removable heating coil in an audible format;
wherein the logic module controls the operation of the speaker;
wherein the timing circuit is an electric circuit that is incorporated in the logic module;
wherein the timing circuit forms a countdown timing device used by the logic module to limit the amount of time the heating circuit can operate.

20. The air fryer with removable heating coil according to claim 19
wherein the national electric grid is an externally provided source of electric energy;
wherein the national electric grid port is a port used to transmit electric energy from the national electric grid to the heating circuit;
wherein the ac/dc converter is an electric circuit;
wherein the ac/dc converter converts ac electric energy from the national electric grid port and converts the received ac electric energy into the dc electric energy required to operate the logic circuit;
wherein the national electric grid plug is a plug used to draw electric energy from the national electric grid through the national electric grid port;
wherein the national electric grid plug forms electric connections with both the ac/dc converter and the relay switch.
